(19) United States
(12) Patent Application Publication
(10) Pub. No.: US 2007/0222359 A1
(43) Pub. Date: Sep. 27, 2007

(54) Color cathode-ray tube apparatus

(75) Inventor: Kenichiro Taniwa, Takatsuki-shi (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/703,512

(22) Filed: Feb. 7, 2007

(30) Foreign Application Priority Data
Mar. 24, 2006 (JP) 2006-083637

(51) Int. Cl. H01J 29/70; H01J 29/74; H01J 29/46

(52) U.S. Cl. 313/440; 313/441; 313/433

(57) ABSTRACT

A deflection device includes a first magnetic field generator, which generates a magnetic field of the same polarity as that of a vertical deflection magnetic field during upward deflection, on an upper side from an XZ-plane, a second magnetic field generator, which generates a magnetic field of the same polarity as that of a vertical deflection magnetic field during downward deflection, on a lower side from the XZ-plane, a third magnetic field generator, which generates a magnetic field of a polarity opposite to that of the vertical deflection magnetic field during upward deflection, on the upper side from the XZ-plane, and a fourth magnetic field generator, which generates a magnetic field of a polarity opposite to that of the vertical deflection magnetic field during downward deflection, on the lower side from the XZ-plane. The first and second magnetic field generators are placed away from a core on an opposite side of a tube axis with respect to an outermost peripheral edge of the core on a phosphor screen side. The third and fourth magnetic field generators are placed between the core and the separator on the phosphor screen side from a center position of the core in a tube-axis direction. Because of this, a variation in raster distortion characteristics due to a change in temperature can be reduced simply at low cost.

### BACKGROUND OF THE INVENTION

1. Field of the Invention

The present invention relates to a color cathode-ray tube apparatus used for a TV, a monitor, or the like.

2. Description of Related Art

Nowadays, a so-called self-convergence in-line color cathode-ray tube apparatus is in wide use. This color cathode-ray tube apparatus includes an in-line electron gun for emitting three aligned electron beams of a center beam and a pair of side beams on both sides of the center beam that pass in the same horizontal plane, a deflection device for generating a pincushion horizontal deflection magnetic field and a barrel vertical deflection magnetic field, and a pair of upper and lower permanent magnets or a pair of upper and lower and a pair of right and left permanent magnets provided at an edge of a screen-side opening of the deflection device for fine-tuning these horizontal and vertical deflection magnetic fields. In this color cathode-ray tube apparatus, the three electron beams are converged over an entire screen, and the electron gun and the deflection device are combined so that deflection distortion (raster distortion) in upper and lower portions or upper, lower, right and left portions of the screen is corrected to be substantially straight.

Conventionally, suggestions have been made to provide the deflection device with various auxiliary devices, thereby enhancing raster distortion performance, and to reduce variations in convergence performance and raster distortion due to a change in temperature.

For example, JP 2001-52631 A and JP 7(1995)-15736 A disclose that a temperature compensating circuit device is provided at a deflection device so as to reduce the variation in convergence characteristics due to a change in temperature.

Furthermore, JP 63(1988)-62139 A discloses that a magnetic temperature compensating device, in which a member with a temperature coefficient different from that of a magnet for correcting raster distortion is attached to the magnet, is provided at a deflection device so as to reduce the variation in raster distortion characteristics due to a change in temperature.

JP 2001-160364 A and JP 2001-243899 A disclose that, in addition to a pair of first magnets for correcting pincushion raster distortion in upper and lower portions, a pair of second magnets of a polarity opposite to that of the pair of first magnets are provided in upper and lower portions of an edge of a screen-side opening of the deflection device.

JP 6(1994)-283115 A and JP 58(1983)-32892 B disclose that a pair of first magnets for correcting pincushion raster distortion in upper and lower portions are provided in upper and lower portions of an edge of a screen-side opening of the deflection device, and a pair of second magnets of a polarity opposite to that of the pair of first magnets are provided on an inner circumferential surface of the deflection device in the vicinity of a center position of a core in a tube-axis direction.

Recently, the demand for high image quality and low cost is increasing year after year with respect to a television device using a color cathode-ray tube apparatus. Therefore, in terms of cost, it is becoming difficult to mount an additional expensive or complicated device to enhance image quality.

According to the temperature compensating circuit device disclosed in JP 2001-52631 A and JP 7 (1995)-15736 A, although the variation in convergence characteristics due to a change in temperature can be reduced, the variation in raster distortion characteristics due to a change in temperature cannot be reduced. Furthermore, it is necessary to modify the design of each element of the temperature compensating circuit device in accordance with the impedance of the deflection device. There also is a problem that the deflection device becomes complicated and expensive.

According to the magnetic temperature compensating device disclosed in JP 63(1988)-62139 A, although the variation in raster distortion characteristics due to a change in temperature can be reduced, a special member with a positive temperature coefficient, which is to be used together with a widely used magnet with a negative temperature coefficient, is expensive.

According to the two pairs of magnets disclosed in JP 2001-160364 A and JP 2001-243899 A, although raster distortion in upper and lower portions is reduced, the variation in raster distortion characteristics due to a change in temperature cannot be reduced sufficiently. Furthermore, the linearity of rasters in right and left portions and convergence cannot be satisfied merely by adjusting the magnetic field distribution of the deflection device. Therefore, in order to correct raster distortion in right and left portions, for example, it is necessary to add a correction circuit to a television set, which renders the device complicated and expensive.

According to the two pairs of magnets disclosed in JP 6(1994)-283115 A and JP 58(1983)-32892 B, although raster distortion in upper and lower portions is reduced, the variation in raster distortion characteristics due to a change in temperature cannot be reduced sufficiently.

### SUMMARY OF THE INVENTION

The present invention has been achieved so as to solve the above-mentioned problems of conventional color cathode-ray tube apparatuses, and its object is to provide an inexpensive color cathode-ray tube apparatus in which the variation in raster distortion characteristics due to a change in temperature is reduced with a simple configuration without adding an auxiliary correcting device using a special material or a complicated auxiliary correcting device.

A color cathode-ray tube apparatus of the present invention includes: a color cathode-ray tube having an electron gun for emitting three electron beams aligned in a horizontal direction and a phosphor screen for emitting light when struck by the three electron beams emitted from the electron gun; and a deflection device having a horizontal deflection coil for generating a horizontal deflection magnetic field that deflects the three electron beams in the horizontal direction, a vertical deflection coil for generating a vertical deflection magnetic field that deflects the three electron beams in a vertical direction, a core for enhancing a magnetic efficiency of the horizontal deflection coil and the vertical deflection coil, and a separator placed outside of the horizontal deflection coil and inside of the vertical deflection coil and the core.

The deflection device includes: a first magnetic field generator for generating a magnetic field of the same polarity as that of a magnetic field generated by the vertical deflection coil when the three electron beams are deflected upward, on an upper side from a horizontal plane including a tube axis and a horizontal axis; a second magnetic field generator for generating a magnetic field of the same polarity as that of the magnetic field generated by the vertical deflection coil when the three electron beams are deflected downward, on a lower side from the horizontal plane; a third magnetic field generator for generating a magnetic field of a polarity opposite to that of the magnetic field generated by the vertical deflection coil when the three electron beams are deflected upward, on the upper side from the horizontal plane; and a fourth magnetic field generator for generating a magnetic field of the polarity opposite to that of the magnetic field generated by the vertical deflection coil when the three electron beams are deflected downward, on the lower side from the horizontal plane.

The first and second magnetic field generators are placed away from the core on an opposite side of a tube axis with respect to an outermost peripheral edge of the core on the phosphor screen side. The third and fourth magnetic field generators are placed between the core and the separator on the phosphor screen side from a center position of the core in a tube-axis direction.

### BRIEF DESCRIPTION OF THE DRAWINGS

FIG. 1 is a half cross-sectional view showing a schematic configuration of a color cathode-ray tube apparatus according to one embodiment of the present invention.

FIG. 2 is a view showing a horizontal deflection magnetic field generated by a horizontal deflection coil at a certain moment in the color cathode-ray tube apparatus according to one embodiment of the present invention.

FIG. 3 is a view showing a vertical deflection magnetic field generated by a vertical deflection coil at a certain moment in the color cathode-ray tube apparatus according to one embodiment of the present invention.

FIG. 4A is a front view showing the arrangement of magnetic poles of a first pair of permanent magnets seen from a phosphor screen side in the color cathode-ray tube apparatus according to one embodiment of the present invention, and FIG. 4B is a view showing the action on rasters in upper and lower portions of a quadrupole magnetic field generated by the first pair of permanent magnets.

FIG. 5A is a front view showing the arrangement of magnetic poles of a second pair of permanent magnets seen from the phosphor screen side in the color cathode-ray tube apparatus according to one embodiment of the present invention, and FIG. 5B is a view showing the action on rasters in upper and lower portions of a quadrupole magnetic field generated by the second pair of permanent magnets.

FIG. 6A is an enlarged cross-sectional view of a portion VIA in FIG. 1. FIG. 6B is a cross-sectional view taken along a vertical plane including a tube axis and a vertical axis, showing the periphery of a third magnetic field generator in a color cathode-ray tube apparatus according to another embodiment of the present invention.

FIG. 7 is a view showing a method for measuring a magnetic force of a permanent magnet.

### DETAILED DESCRIPTION OF THE INVENTION

According to the present invention, an inexpensive color cathode-ray tube apparatus can be provided in which the variation in raster distortion characteristics due to a change in temperature is reduced with a simple configuration without adding an auxiliary correcting device.

Hereinafter, a color cathode-ray tube apparatus according to one embodiment of the present invention will be described with reference to the drawings.

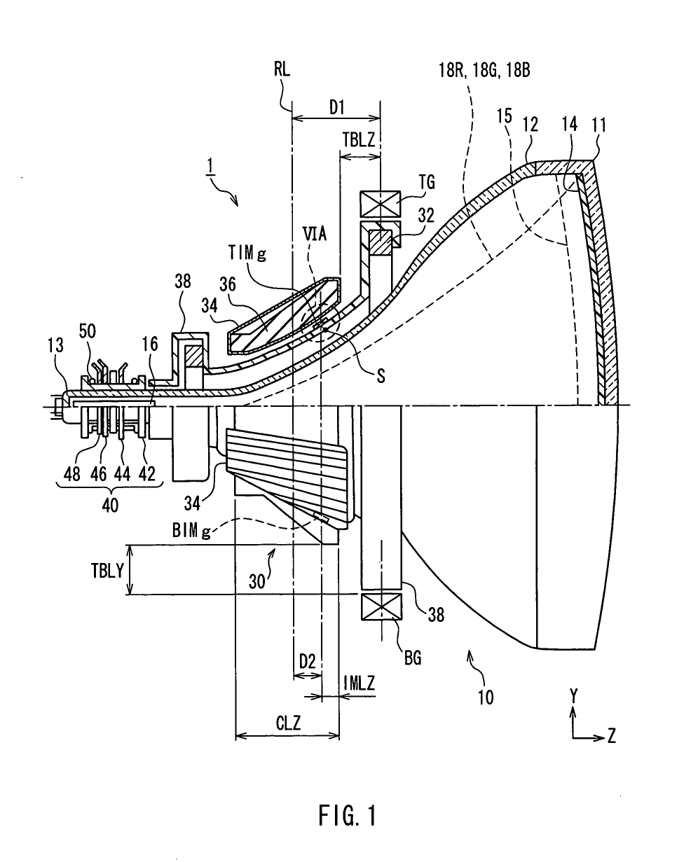

FIG. 1 is a half cross-sectional view showing a schematic configuration of the color cathode-ray tube apparatus according to one embodiment of the present invention. For convenience of the following description, it is assumed that a tube axis is a Z-axis, a horizontal (screen long-side direction) axis is an X-axis, and a vertical (screen short-side direction) axis is a Y-axis. The X-axis and the Y-axis cross each other at right angles on the Z-axis. In FIG. 1, a cross-sectional view is shown on an upper side from the Z-axis, and the outer appearance view is shown on a lower side therefrom.

As shown in FIG. 1, a color cathode-ray tube apparatus 1 includes a color cathode-ray tube 10, a deflection device 30, a convergence purity unit (CPU) 40, a velocity modulation coil 50, and the like.

The color cathode-ray tube 10 includes a glass bulb formed by joining a face panel 11 and a funnel 12 together, and a shadow mask 15 and an in-line electron gun (hereinafter, simply referred to as an “electron gun”) 16 that are contained in the glass bulb.

An inner surface of the face panel 11 is provided with a substantially rectangular phosphor screen 14 formed by arranging respective phosphor dots (or phosphor stripes) of red, green, and blue in a regular manner. The shadow mask 15 is provided at a substantially constant distance from the phosphor screen 14. The shadow mask 15 is provided with a number of dot-shaped or slot-shaped electron beam passage apertures. Three electron beams 18R, 18G, 18B (three electron beams are arranged in a straight line parallel to the X-axis, so that only one electron beam on the front side is shown in the figure) emitted from the electron gun 16 pass through the electron beam passage apertures provided in the shadow mask 15, and strike the desired phosphors to cause them to emit light.

The electron gun 16 is provided inside a neck 13 of the funnel 12. The electron gun 16 emits three electron beams that are in-line aligned on the horizontal axis (X-axis), namely, a center beam 18G placed at the center, and a pair of side beams 18R, 18B arranged on both sides in the X-axis direction with respect to the center beam 18G toward the phosphor screen 14.

The deflection device 30 is provided on an outer circumferential surface of a portion of the funnel 12, extending from a large-diameter portion to the neck 13. The deflection device 30 is a saddle-toroidal deflection device including a saddle-type horizontal deflection coil 32 and a toroidal vertical deflection coil 34 as a main deflection coil. The vertical deflection coil 34 is wound around a ferrite core (hereinafter, simply referred to as a “core”) 36. The core 36 has a substantially funnel shape with a large-diameter portion on the phosphor screen 14 side and a small-diameter portion on the electron gun 16 side, and enhances the magnetic efficiency of a vertical deflection magnetic field generated by the vertical deflection coil 34 and a horizontal deflection magnetic field generated by the horizontal deflection coil 32. A resin frame (separator) 38 is provided between the vertical deflection coil 34 and the core 36, and the horizontal deflection coil 32 that is placed on the funnel 12 side (inner side) from the vertical deflection coil 34 and the core 36. The resin frame 38 maintains an electrical insulated state between the horizontal deflection coil 32 and the vertical deflection coil 34, and supports both the deflection coils 32, 34.

A winding of the vertical deflection coil 34 is wound around the core 36 with an appropriate distribution so that a desired vertical deflection magnetic field described later is obtained. For example, the winding of the vertical deflection coil 34 may or may not be present on a plane (YZ-plane, i.e., a vertical plane) including the Z-axis and the Y-axis. The upper side from the Z-axis in FIG. 1 shows the case where the winding of the vertical deflection coil 34 is present on the YZ-plane, and the lower side from the Z-axis in FIG. 1 shows the case where the winding of the vertical deflection coil 34 is not present on the YZ-plane.

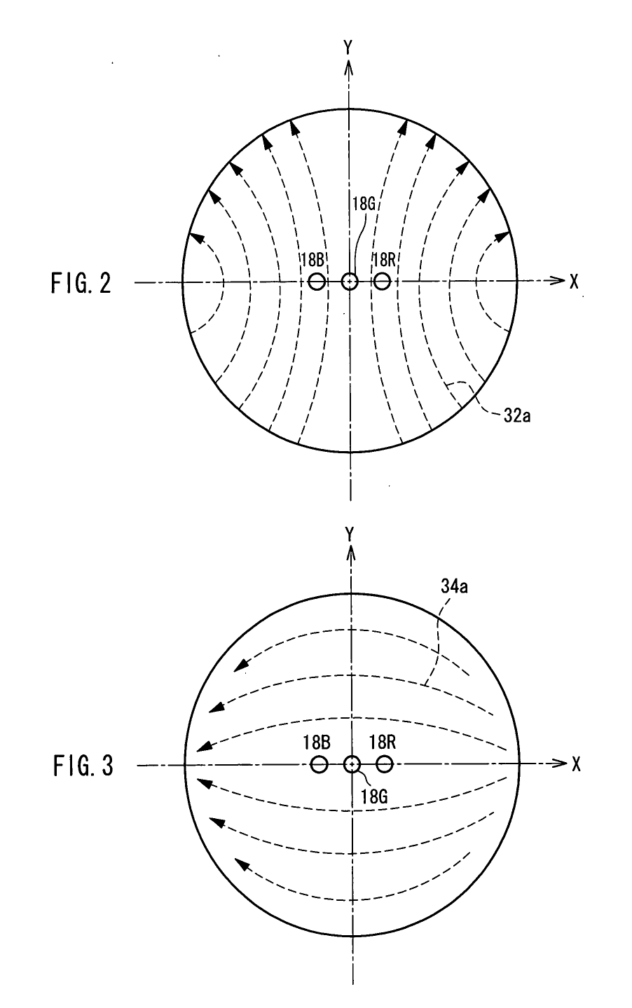

The horizontal deflection coil 32 generates a pincushion horizontal deflection magnetic field 32a as represented by a broken line in FIG. 2, and the vertical deflection coil 34 generates a barrel vertical deflection magnetic field 34a as represented by a broken line in FIG. 3. The three electron beams 18R, 18G, 18B emitted from the electron gun 16 are deflected in a horizontal direction and a vertical direction by the horizontal deflection magnetic field 32a and the vertical deflection magnetic field 34a, and scan on the phosphor screen 14 by raster scanning. Furthermore, due to a non-uniform magnetic field formed by the horizontal deflection magnetic field 32a and the vertical deflection magnetic field 34a, the three electron beams 18R, 18G, 18B are converged over the entire surface of the phosphor screen 14.

The CPU 40 is provided on an outer circumferential surface of the neck 13 at a position overlapping the electron gun 16 in the Z-axis direction, and performs static convergence adjustment and purity adjustment of the three electron beams 18R, 18G, 18B in a center portion of the screen. The CPU 40 includes a purity (color purity) magnet 44, a quadrupole magnet 46, and a hexapole magnet 48 that are attached to a cylindrical resin frame 42. The purity magnet 44, the quadrupole magnet 46, and the hexapole magnet 48 respectively are formed of a set of two annular magnets.

The velocity modulation coil 50 is formed of a pair of loop coils that are disposed on both sides so as to sandwich a plane (an XZ-plane, i.e., a horizontal plane) including the X-axis and the Z-axis. The pair of loop coils are attached to the resin frame 42 of the CPU 40 so as to be substantially symmetrical with respect to the Z-axis. The pair of loop coils are supplied with a current in accordance with a velocity modulation signal obtained by differentiating a video signal. The velocity modulation coil 50 generates a vertical magnetic field so as to modulate a horizontal scanning velocity of the electron beams, thereby performing an edge enhancement for an image.

The deflection device 30 includes a first pair of permanent magnets TG, BG forming a pair with each other and a second pair of permanent magnets TIMg, BIMg forming a pair with each other. The first pair of permanent magnets TG, BG and the second pair of permanent magnets TIMg, BIMg are both placed on a plane (a YZ-plane) including the Y-axis and the Z-axis.

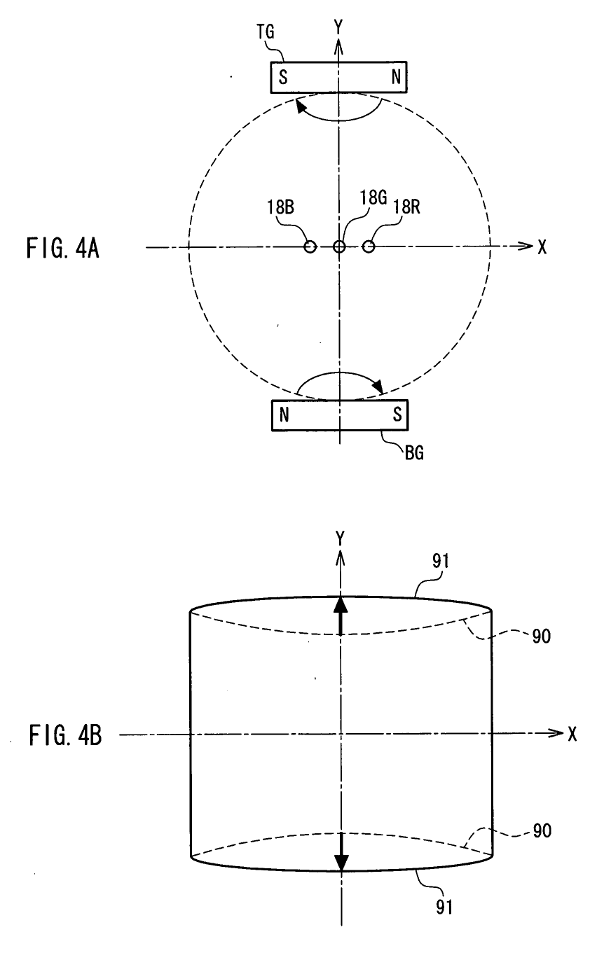

FIG. 4A is a front view showing the arrangement of magnetic poles of the first pair of permanent magnets TG, BG seen from the phosphor screen 14 side and a magnetic field formed by this arrangement. As shown, the permanent magnets TG and BG are the same permanent magnets, and the positions and the directions of the magnetic poles thereof are symmetrical with respect to the Z-axis.

The permanent magnet TG first magnetic field generator) placed on the upper side from the XZ-plane generates a magnetic field of the same polarity as that of a magnetic field generated by the vertical deflection coil 34 so that the three electron beams 18B, 18G, 18R are deflected to the upper side from the XZ-plane. The permanent magnet BG (second magnetic field generator) placed on the lower side from the XZ-plane generates a magnetic field of the same polarity as that generated by the vertical deflection coil 34 so that the three electron beams 18B, 18G, 18R are deflected to the lower side from the XZ-plane. That is, the first pair of permanent magnets TG, BG generate a quadrupole magnetic field that attracts the three electron beams 18B, 18G, 18R, which are deflected to the vicinity of upper and lower ends on the Y-axis on the screen, to the upper and lower ends. Thus, as shown in FIG. 4B, the first pair of permanent magnets TG, BG reduce pincushion raster distortion in upper and lower portions represented by dotted lines 90 in a manner as represented by solid lines 91 (i.e., bring rasters in upper and lower portions close to a barrel shape).

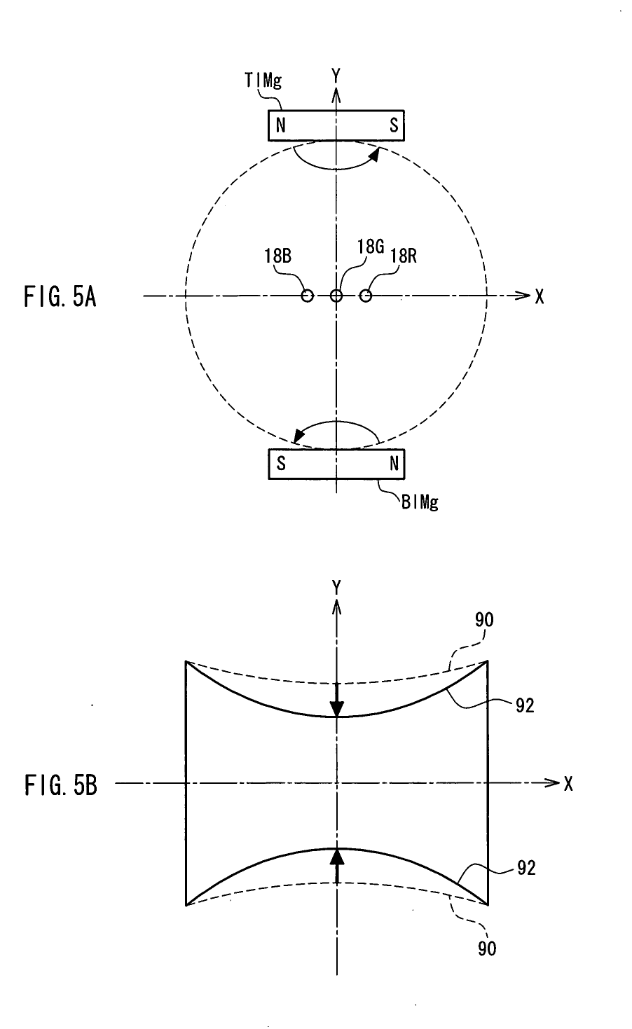

FIG. 5A is a front view showing the arrangement of magnetic poles of the second pair of permanent magnets TIMg, BIMg seen from the phosphor screen 14 side, and a magnetic field formed by this arrangement. As shown, the permanent magnets TIMg and BIMg are the same permanent magnets, and the positions and the directions of magnetic poles thereof are symmetrical with respect to the Z-axis.

The permanent magnet TIMg (third magnetic field generator) placed on the upper side from the XZ-plane generates a magnetic field of a polarity opposite to that of a magnetic field generated by the vertical deflection coil 34 so that the three electron beams 18B, 18G, 18R are deflected to the upper side from the XZ-plane. The permanent magnet BIMg (fourth magnetic field generator) placed on the lower side from the XZ-plane generates a magnetic field of a polarity opposite to that of the magnetic field generated by the vertical deflection coil 34 so that the three electron beams 18B, 18G, 18R are deflected to the lower side from the XZ-plane. More specifically, the second pair of permanent magnets TIMg, BIMg generate a quadrupole magnetic field that attracts the three electron beams 18B, 18G, 18R, which are deflected to the vicinity of upper and lower ends on the Y-axis of the screen, to the center of the screen. Thus, as shown in FIG. 5B, the second pair of permanent magnets TIMg, BIMg increase pincushion raster distortion in upper and lower portions represented by dotted lines 90 in a manner as represented by solid lines 92.

As shown in FIG. 1, the first pair of permanent magnets TG, BG are placed in the vicinity of the end of the core 36 on the large-diameter side. More specifically, in the Y-axis direction, the first pair of permanent magnets TG, BG are placed away from the core 36 on a side opposite to the Z-axis with respect to an outermost peripheral edge of the core 36 on the large-diameter side. Furthermore, it is preferable that, in the Z-axis direction, the center of the first pair of permanent magnets TG, BG is placed at the same position as that of the end of the core 36 on the large-diameter side or on the phosphor screen 14 side therefrom.

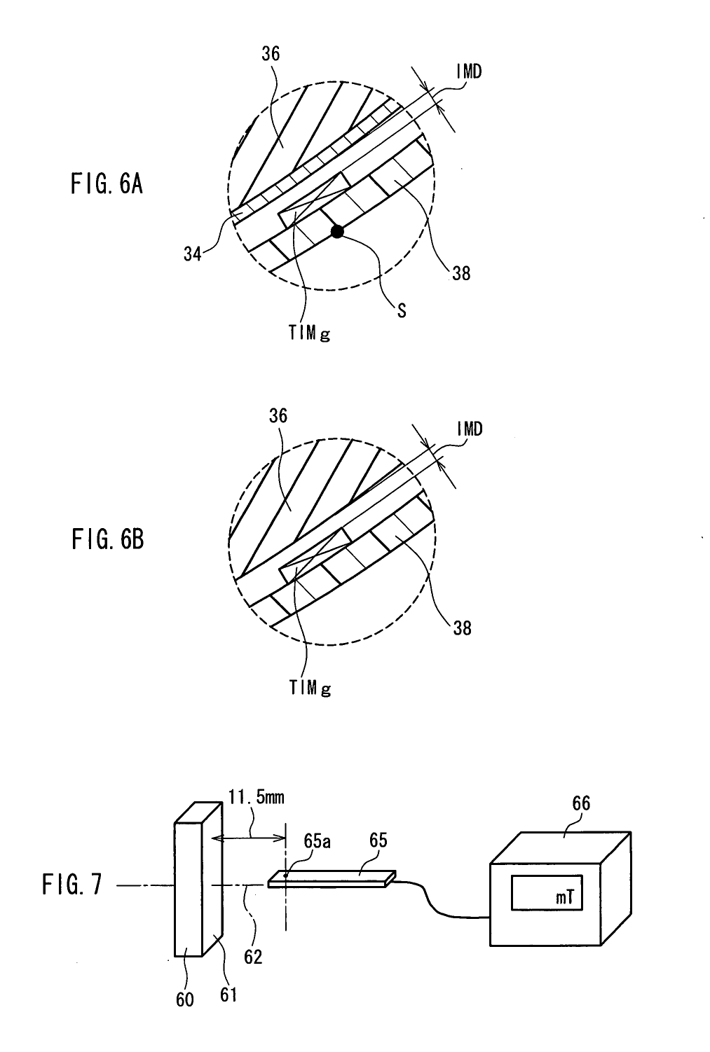

As shown in FIG. 1, the second pair of permanent magnets TIMg, BIMg are placed so that the center of the second pair of permanent magnets TIMg, BIMg is positioned on the phosphor screen 14 side from the center position of the core 36 in the Z-axis direction. In the Z-axis direction, it is preferable that the center of the second pair of permanent magnets TIMg, BIMg is positioned on the electron gun 16 side from the end of the core 36 on the large-diameter side. Furthermore, the second pair of permanent magnets TIMg, BIMg are placed between the core 36 and the resin frame 38 as shown in FIGS. 6A and 6B.

The experimental results will be shown, in the case of applying the present invention to a 21-inch color cathode-ray tube apparatus with a deflection angle of 90° (hereinafter, referred to as an “example”).

The color cathode-ray tube apparatus of the present example was set as shown in FIG. 1. As shown on the upper side from the Z-axis in FIG. 1, the winding of the vertical deflection coil 34 also was placed on the YZ-plane.

As the first pair of permanent magnets TG, BG, permanent magnets with a magnetic force of 3.5 mT in the shape of a rectangular parallelepiped were used, which had a length in the X-axis direction of 51 mm, a dimension in the Y-axis direction of 10 mm, and a dimension in the Z-axis direction of 11.5 mm. AY-axis direction distance TBLY from the outermost peripheral edge of the core 36 on the large-diameter side to the first pair of permanent magnets TG, BG was set to be 6 mm, and a Z-axis direction distance TBLZ from the end of the core 36 on the large-diameter side to the center of the first pair of permanent magnets TG, BG was set to be 5 mm. The magnetic poles of the first pair of permanent magnets TG, BG were arranged as shown in FIG.4A.

As the second pair of permanent magnets TIMg, BIMg, permanent magnets with a magnetic force of 0.5 mT in the shape of a thin plate were used, which had longitudinal and lateral dimensions of 5 mm and a thickness of 1 mm. As shown in FIG. 6A, the second pair of permanent magnets TIMg, BIMg were attached to the resin frame 38 along an outer circumferential surface thereof (i.e., diagonally with respect to the XZ-plane) between the resin frame 38 and the vertical deflection coil 34. A distance IMD from the inner circumferential surface of the vertical deflection coil 34 to the second pair of permanent magnets TIMg, BIMg was 0.5 mm. AZ-axis direction distance IMLZ from the end of the core 36 on the large-diameter side to the center of the second pair of permanent magnets TIMg, BIMg was 5 mm. The magnetic poles of the second pair of permanent magnets TIMg, BIMg were arranged as shown in FIG. 5A.

A method for measuring the above-mentioned magnetic force (magnetic flux density) of the first pair of permanent magnets TG, BG and the second pair of permanent magnets TIMg, BIMg will be described with reference to FIG. 7. A magnetic field measurement probe 65 was set so as to be opposed to an end face 61 of a permanent magnet 60 to be measured. At this time, a measurement point 65a of the probe 65 was placed on a normal line 62 set up at a center point of the end face 61, and the distance from the end face 61 to the measurement point 65a was set to be 11.5 mm. Herein, in the case where the permanent magnet 60 was the first pair of permanent magnets TG, BG, the end face 61 was set to be a plane opposed to the Z-axis when the permanent magnet 60 was mounted on the deflection device 30, and in the case where the permanent magnet 60 was the second pair of permanent magnets TIMg, BIMg, the end face 61 was set to be a plane opposed to the resin frame 38 when the permanent magnet 60 was mounted on the deflection device 30. Thus, a magnetic flux density at the measurement point 65a was obtained by an arithmetic operation device 66, and was determined to be the magnetic force of the permanent magnet 60. The measurement was conducted in an atmosphere of 25° C.

As the first pair of permanent magnets TG, BG, and the second pair of permanent magnets TIMg, BIMg, widely used inexpensive ferrite-based permanent magnets were used. The temperature coefficient of the magnetic force thereof was about −0.2%/° C., and thus, the permanent magnets had characteristics in which the magnetic force decreases along with an increase in temperature.

A Z-axis direction length CLZ of the core 36 was 37 mm. A Z-axis direction distance D1 from a reference line RL to the center of the first pair of permanent magnets TG, BG was 15 mm, and a Z-axis direction distance D2 from the reference line RL to the center of the second pair of permanent magnets TIMg, BIMg was 5 mm. Herein, the “reference line RU” refers to a virtual reference line perpendicular to the Z-axis, and the position of the reference line RL on the Z-axis is matched with a geometric deflection center position of a cathode-ray tube.

The color cathode-ray tube apparatus was set in a constant temperature chamber, and the temperature of the color cathode-ray tube apparatus during power-off was set to be the same as room temperature. After that, the color cathode-ray tube apparatus was activated, and a change in temperature of each part in the deflection device 30 was measured. The increase in temperature in each part with respect to the room temperature in a state where the temperature of each part in the deflection device 30 was stable was as follows. The increase in temperature of an inner circumferential surface of the vertical deflection coil 34 was 44° C. The increase in temperature at a point of 0.5 mm from the inner circumferential surface of the vertical deflection coil 34 to the resin frame 38 side, i.e., on the surfaces of the second pair of permanent magnets TIMg, BIMg on the sides opposed to the vertical deflection coil 34 was 42° C. The increase in temperature at a point of 6 mm in the Y-axis direction on an opposite side of the Z-axis from the outermost peripheral edge of the core 36 on the large-diameter side and 5 mm in the Z-axis direction on the phosphor screen 14 side from the end of the core 36 on the large-diameter side, i.e., on the surfaces of the first pair of permanent magnets TG, BG on the sides opposed to the Z-axis was 13° C. The increase in temperature in the vicinity of a position S (see FIG. 6A) on an inner circumferential surface of the separator 38 corresponding to each position on the outer circumferential surface of the separator 38 where the second pair of permanent magnets TIMg, BIMg were attached was 17° C.

In a state of the deflection device 30 immediately after the activation of the color cathode-ray tube apparatus before the temperature increased, and in a state of the deflection device 30 after the activation where the temperature increased to be stable, a variation in raster distortion in upper and lower portions on the screen was measured. Consequently, rasters in upper and lower portions that had been in a pincushion shape before the increase in temperature changed to a pincushion side by 0.3% after the increase in temperature.

In contrast, in the case of using only the first pair of permanent magnets TG, BG without using the second pair of permanent magnets TIMg, BIMg, rasters in upper and lower portions that had been in a pincushion shape before the increase in temperature of the deflection device 30 changed to a pincushion side by 1.0% after the increase in temperature.

Furthermore, in the case of using only the second pair of permanent magnets TIMg, BIMg without using the first pair of permanent magnets TG, BG, rasters in upper and lower portions that had been in a pincushion shape before the increase in temperature of the deflection device 30 changed to a barrel side by 0.7% after the increase in temperature.

Herein, the rasters in upper and lower portions “changing to a pincushion side” refers to the following: the rasters in upper and lower portions change so that portions in the vicinity of the Y-axis of the rasters in upper and lower portions approach the Z-axis, as in changes from the dotted lines 90 to the solid lines 92 in FIG. 5B, irrespective of whether the changed shape is a pincushion shape or a barrel shape. Furthermore, the rasters in upper and lower portions “changing to a barrel side” refers to the following: the rasters in upper and lower portions change so that portions in the vicinity of the Y-axis of the rasters in upper and lower portions move away from the Z-axis, as in changes from the dotted lines 90 to the solid lines 91 in FIG. 4B, irrespective of whether the changed shape is a pincushion shape or a barrel shape.

A preferable range of the change amount of the rasters in upper and lower portions before and after the increase in temperature of the deflection device 30 is 0.5% or less even in the case of any change to a pincushion side and a barrel side, and this was satisfied by the above-mentioned example using the first pair of permanent magnets TG, BG and the second pair of permanent magnets TIMg, BIMg.

A color cathode-ray tube apparatus having a deflection device with two pairs of permanent magnets attached thereto in a similar manner to that of the present invention is found conventionally. However, in the conventional color cathode-ray tube apparatus, the change amount of rasters in upper and lower portions before and after the increase in temperature of the deflection device 30 is larger than 0.5%, and the change amount of rasters in upper and lower portions before and after the increase in temperature of the deflection device may be larger than 1% if a variation caused by an assembly error of the deflection device is included. In contrast, in the present invention, the change amount of rasters in upper and lower portions before and after the increase in temperature of the deflection device 30 can be suppressed to be 0.5% or less stably even if a variation between color cathode-ray tube apparatuses caused by an assembly error of the deflection device 30 is included.

As described above, according to the present invention, the deflection device 30 includes the first pair of permanent magnets TG, BG and the second pair of permanent magnets TIMg, BIMg, whereby a variation in distortion characteristics of rasters in upper and lower portions due to the increase in temperature can be reduced. The reason for this will be described below.

In a color cathode-ray tube apparatus including a deflection device that generates a self-convergence magnetic field formed of the pincushion horizontal deflection magnetic field 32a shown in FIG. 2 and the barrel vertical deflection magnetic field 34a shown in FIG. 3, when an attempt is made so as to flatten the outer surface of the face panel 11 (which is mainstream recently), an astigmatic aberration increases, and rasters in the upper and lower portions are distorted in a pincushion shape. In the present invention, using the first pair of permanent magnets TG, BG and the second pair of permanent magnets TIMg, BIMg, of which actions on rasters in upper and lower portions are opposite to each other as shown in FIGS. 4B and 5B, the pincushion distortion of rasters in upper and lower portions is corrected.

The magnetic force of a widely used permanent magnet has a negative temperature dependency in which the magnetic force becomes weak along with the increase in temperature. Thus, when the temperature of the first pair of permanent magnets TG, BG increases, the quadrupole magnetic field generated by the first pair of permanent magnets TG, BG shown in FIG. 4A is weakened, and the action on the rasters in upper and lower portions shown in FIG. 4B becomes weak. More specifically, as the temperature of the first pair of permanent magnets TG, BG increases, the action of the first pair of permanent magnets TG, BG of correcting pincushion distortion of rasters in upper and lower portions becomes weak, and the rasters in upper and lower portions change to a pincushion side.

Furthermore, when the temperature of the second pair of permanent magnets TIMg, BIMg increases, the quadrupole magnetic field generated by the second pair of permanent magnets TIMg, BIMg shown in FIG. 5A is weakened, and the action on the rasters in upper and lower portions shown in FIG. 5B becomes weak. More specifically, as the temperature of the second pair of permanent magnets TIMg, BIMg increases, the rasters in upper and lower portions change to a barrel side.

As described above, the temperature-induced variation of the effect of the first pair of permanent magnets TG, BG on the rasters in upper and lower portions tends to be negated by the temperature-induced variation of the effect of the second pair of permanent magnets TIMg, BIMg on the rasters in upper and lower portions.

As is apparent from the above example, the increase in temperature of each part in the deflection device 30 when the color cathode-ray tube apparatus is activated is not uniform. The main heat generation sources of the deflection device 30 are the horizontal deflection coil 32 and the vertical deflection coil 34. In general, in the Z-axis direction, the increase in temperature in the deflection device 30 becomes maximum at a position (at a position on the Z-axis where the deflection magnetic field distribution on the Z-axis becomes maximum or in the vicinity thereof) slightly on the electron gun 16 side from the center position of the core 36 in the Z-axis direction, and in the Y-axis direction passing through the above-mentioned position on the Z-axis, the increase in temperature in the deflection device 30 becomes largest to be 45° C. to 50° C. at a position in the horizontal deflection coil 34, 40° C. to 45° C. on an inner circumferential surface of the core 36, and 35° C. to 40° C. on an outer circumferential surface of the core 36.

Thus, when the attachment positions in the deflection device of the first pair of permanent magnets TG, BG and the second pair of permanent magnets TIMg, BIMg are different from each other, the amounts of temperature increase may be different from each other between the first pair of permanent magnets TG, BG, and the second pair of permanent magnets TIMg, BIMg. In this case, for example, even when the first pair of permanent magnets TG, BG and the second pair of permanent magnets TIMg, BIMg are placed so that the pincushion distortion of the rasters in upper and lower portions is corrected satisfactorily in a state before the increase in temperature immediately after the activation, after that, the relative relationship between the action of the first pair of permanent magnets TG, BG on the rasters in upper and lower portions and the action of the second pair of permanent magnets TIMg, BIMg on the rasters in upper and lower portions changes as the temperature of the deflection device increases, with the result that the raster distortion in upper and lower portions is degraded remarkably. That is, merely by placing the first pair of permanent magnets TG, BG and the second pair of permanent magnets TIMg, BIMg, the static characteristics of raster distortion in upper and lower portions without a variation in a change in temperature and the dynamic characteristics thereof when the temperature increases cannot be satisfied.

According to the present invention, attention is focused on the fact that the increase amount of temperature varies depending upon the position in the deflection device, and the first pair of permanent magnets TG, BG and the second pair of permanent magnets TIMg, BIMg are placed at optimum positions as described above. Because of this, a variation in upper and lower raster distortion characteristics due to a change in temperature can be reduced.

Furthermore, in the present invention, since the raster distortion in upper and lower portions is corrected using permanent magnets, the same permanent magnets also can be used in the deflection device with different impedance. Thus, the cost of a color cathode-ray tube apparatus can be reduced.

Furthermore, although the detailed description is omitted, the first pair of permanent magnets TG, BG and the second pair of permanent magnets TIMg, BIMg also have the function of enhancing convergence characteristics by generating the quadrupole magnetic fields shown in FIGS. 4A and 5A. According to the present invention, a variation in convergence characteristics due to a change in temperature also can be reduced.

It is preferable that the first pair of permanent magnets TG, BG, and the second pair of permanent magnets TIMg, BIMg have a negative temperature coefficient with respect to the magnetic characteristics. Herein, the phrase “having a negative temperature coefficient with respect to magnetic characteristics” refers to the magnetic characteristics in which a magnetic force (magnetic flux density) is weakened along with the increase in temperature. Because of this, an inexpensive widely used permanent magnet can be used.

It is preferable that the first pair of permanent magnets TG, BG have a magnetic force larger than that of the second pair of permanent magnets TIMg, BIMg. By using a combination of the first pair of permanent magnets TG, BG and the second pair of permanent magnets TIMg, BIMg that have different magnetic forces, the pincushion distortion of the rasters in upper and lower portions in a state without a change in temperature can be corrected. Furthermore, the first pair of permanent magnets TG, BG having a relatively strong magnetic force are placed at positions where the increase in temperature is relatively small, and the second pair of permanent magnets TIMg, BIMg having a relatively weak magnetic force are placed at positions where the increase in temperature is relatively large, whereby a variation in distortion characteristics of rasters in upper and lower portions in the case where there is a change in temperature can be reduced.

The magnetic force (magnetic flux density) of the first pair of permanent magnets TG, BG measured by the method shown in FIG. 7 is TBT, and the magnetic force (magnetic flux density) of the second pair of permanent magnets TIMg, BIMg measured by the method shown in FIG. 7 is IMgT, it is preferable that a ratio IMgT/TBT satisfies 0.01≦IMgT/TBT≦0.3. When the ratio IMgT/TBT satisfies the above relationship in the case where the first pair of permanent magnets TG, BG and the second pair of permanent magnets TIMg, BIMg are attached to the above positions, the correction of pincushion distortion of rasters in upper and lower portions in a state without a change in temperature and the reduction in a variation in distortion characteristics of rasters in upper and lower portions in the case where there is a change in temperature can be satisfied easily.

As shown in FIG. 6A, in the case where a winding of the vertical deflection coil 34 is present between the second pair of permanent magnets TIMg, BIMg and the core 36 in the cross-section along the YZ-plane, it is preferable that the distance IMD between the second pair of permanent magnets TIMg, BIMg and the inner circumferential surface of the vertical deflection coil 34 satisfies 0 mm≦IMD≦2 mm. When the distance IMD exceeds 2 mm, the second pair of permanent magnets TIMg, BIMg become far from the vertical deflection coil 34 that is a heat generation source, so that the increase in temperature of the second pair of permanent magnets TIMg, BIMg becomes small. Thus, the effect of the present invention of reducing a variation in distortion characteristics of rasters in upper and lower portions in the case where there is a change in temperature is weakened.

As shown in FIG. 6B, according to the present invention, in the cross-section along the YZ-plane, the winding of the vertical deflection coil 34 may not be present between the second pair of permanent magnets TIMg, BIMg, and the core 36. In this case, it is preferable that the distance IMD between the second pair of permanent magnets TIMg, BIMg, and the inner circumferential surface of the core 36 satisfies 0 mm≦IMD≦2 mm. When the distance IMD exceeds 2 mm, the second pair of permanent magnets TIMg, BIMg become far from the core 36 around which the vertical deflection coil 34 that is a heat generation source is wound in a toroidal shape, so that the increase in temperature of the second pair of permanent magnets TIMg, BIMg becomes small. Thus, the effect of the present invention of reducing a variation in distortion characteristics of rasters in upper and lower portions in the case where there is a change in temperature is weakened.

Assuming that the Z-axis direction distance between the center in the Z-axis direction of the second pair of permanent magnets TIMg, BIMg and the end of the core 36 on the large-diameter side is IMLZ, and the Z-axis direction length of the core 36 is CLZ, it is preferable that a ratio IMLZ/CLZ satisfies 0≦IMLZ/CLZ≦0.4. Herein, it is assumed that the sign of the distance IMLZ is positive on the electron gun 16 side with respect to the end of the core 36 on the large-diameter side and is negative on the phosphor screen 14 side.

In the Z-axis direction, the deflection amount in the Y-axis direction of the three electron beams 18R, 18G, 18B is small in the vicinity of the center of the core 36 or in a region on the electron gun 16 side therefrom, and increases toward the end of the core 36 on the large-diameter side. Thus, in the case where IMLZ/CLZ≦0.4 is satisfied, the difference between the influence of the second pair of permanent magnets TIMg, BIMg on the three electron beams 18R, 18G, 18B deflected upward and downward in the Y-axis direction and the influence thereof on the three electron beams 18R, 18G, 18B traveling along the Z-axis without being deflected in the Y-axis direction increases, so that the correction by the second pair of permanent magnets TIMg, BIMg with respect to the rasters in upper and lower portions becomes easy.

IMLZ/CLZ<0 means that the center of the second pair of permanent magnets TIMg, BIMg is placed on the phosphor screen 14 side from the end of the core 36 on the large-diameter side in the Z-axis direction. In this case, the second pair of permanent magnets TIMg, BIMg become far from the vertical deflection coil 34 that is a heat generation source and the core 36 around which the vertical deflection coil 34 is wound in a toroidal shape, so that the increase in temperature of the second pair of permanent magnets TIMg, BIMg becomes small. Thus, the effect of the present invention of reducing a variation in distortion characteristics of rasters in upper and lower portions in the case where there is a change in temperature is weakened.

The applicable field of the present invention is not particularly limited, and the present invention can be used in a wide range, for example, in a color cathode-ray tube apparatus for a television, a computer display, or the like of which high resolution and low cost are required.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A color cathode-ray tube apparatus, comprising: a color cathode-ray tube having an electron gun for emitting three electron beams aligned in a horizontal direction and a phosphor screen for emitting light when struck by the three electron beams emitted from the electron gun; and a deflection device having a horizontal deflection coil for generating a horizontal deflection magnetic field that deflects the three electron beams in the horizontal direction, a vertical deflection coil for generating a vertical deflection magnetic field that deflects the three electron beams in a vertical direction, a core for enhancing a magnetic efficiency of the horizontal deflection coil and the vertical deflection coil, and a separator placed outside of the horizontal deflection coil and inside of the vertical deflection coil and the core,
wherein the deflection device includes:
a first magnetic field generator for generating a magnetic field of the same polarity as that of a magnetic field generated by the vertical deflection coil when the three electron beams are deflected upward, on an upper side from a horizontal plane including a tube axis and a horizontal axis;
a second magnetic field generator for generating a magnetic field of the same polarity as that of the magnetic field generated by the vertical deflection coil when the three electron beams are deflected downward, on a lower side from the horizontal plane;
a third magnetic field generator for generating a magnetic field of a polarity opposite to that of the magnetic field generated by the vertical deflection coil when the three electron beams are deflected upward, on the upper side from the horizontal plane; and
a fourth magnetic field generator for generating a magnetic field of the polarity opposite to that of the magnetic field generated by the vertical deflection coil when the three electron beams are deflected downward, on the lower side from the horizontal plane,
the first and second magnetic field generators are placed away from the core on an opposite side of a tube axis with respect to an outermost peripheral edge of the core on the phosphor screen side, and
the third and fourth magnetic field generators are placed between the core and the separator on the phosphor screen side from a center position of the core in a tube-axis direction.

2. The color cathode-ray tube apparatus according to claim 1, wherein any of the first to fourth magnetic field generators have a negative temperature coefficient with respect to magnetic characteristics.

3. The color cathode-ray tube apparatus according to claim 1, wherein the first and second magnetic field generators have a magnetic force stronger than that of the third and fourth magnetic field generators.

4. The color cathode-ray tube apparatus according to claim 1, wherein assuming that a magnetic force of the first and second magnetic field generators is TBT, and a magnetic force of the third and fourth magnetic field generators is IMgT, a ratio IMgT/TBT thereof satisfies 0.01≦IMgT/TBT≦0.3.

5. The color cathode-ray tube apparatus according to claim 1, wherein assuming that, in a cross-section along a vertical plane including a tube axis and a vertical axis, in a case where a winding of the vertical deflection coil is present between the third and fourth magnetic field generators and the core, a distance between the third and fourth magnetic field generators and an inner circumferential surface of the vertical coil is IMD, and in the cross-section, in a case where the winding of the vertical deflection coil is not present between the third and fourth magnetic field generators and the core, a distance between the third and fourth magnetic field generators and an inner circumferential surface of the core is IMD, the distance IMD satisfies 0 mm≦IMD≦2 mm.

6. The color cathode-ray tube apparatus according to claim 1, wherein assuming that a tube-axis direction distance between a center in the tube-axis direction of the third and fourth magnetic field generators and an end of the core on a large-diameter side is IMLZ, and a tube-axis direction length of the core is CLZ, a ratio IMLZ/CLZ thereof satisfies 0≦IMLZ/CLZ≦0.4.
